(19) United States
(12) Patent Application Publication
(10) Pub. No.: US 2005/0231376 A1
(43) Pub. Date: Oct. 20, 2005

(54) Lighting system condition monitoring method and system

(76) Inventors: William Thomas Hatfield, Schenectady, NY (US); Kenneth Brakeley Welles, Scotia, NY (US); James Claude Carnahan, Niskayuna, NY (US); David Michael Davenport, Niskayuna, NY (US)

Correspondence Address: Patrick S. Yoder;FLETCHER YODER, P.O. Box 692289, Houston, TX, 77269-2289, US

(21) Appl. No.: 10/813,368

(22) Filed: Mar. 30, 2004

(51) Int. Cl. G08B 21/00

(52) U.S. Cl. 340/664; 340/652; 340/641; 340/687

(57) ABSTRACT

A system for monitoring the condition of a lighting system comprises a lamp assembly where a lamp is disposed in a housing and a lens is disposed adjacent to the lamp, a conductor disposed on the lens and adapted to lose electrical continuity upon occurrence of a crack in the lens. Furthermore, a monitoring system is coupled to the conductor and is configured to detect the loss of electrical continuity in the conductor, which is indicative of the occurrence of a crack in the railroad signal lens.

### BACKGROUND

The present invention relates generally to the field of lighting and signaling systems and, more specifically to the monitoring and reporting of the condition of lenses and reflectors used in lighting systems, such as in railroad crossing warning equipment.

Various lighting and signaling applications, such as railroad signaling systems, make use of lamps and lighting equipment that are subject to periodic inspection. Such inspections provide valuable information as to the condition or status of the equipment. If found damaged or unworkable, the equipment can then be serviced promptly to maintain good working order. For example, as mandated by United States Federal Railroad Administration (FRA) FRA 234.253, each flashing light unit installed at railroad-highway crossings, is inspected for proper visibility, dirt and damage to the lens and reflectors at least once each month.

Compliance with such regulations currently involves monthly physical examination of the lens and reflector of each flashing light unit, by an inspector, to determine the condition of the lens and reflector and take necessary corrective action.

The costs associated with such manual methods of inspection are very significant. Also, tiny cracks may not be immediately visible to the inspector on cursory inspection. Another problem associated with such a method of manual inspection is that the condition of the lens and reflector between the monthly inspections is not known, which in turn increases the time to repair and might thereby jeopardize safety.

In a number of other applications similar reliability is desired. Such applications may include, for example, marine navigation systems, airport signaling systems, traffic equipment, and so forth. More generally, any lighting system in which reliability is important may benefit from inspection or other techniques useful in evaluating their working state.

It would be desirable to automate such manual processes of inspection of the lighting and signaling systems to alleviate the problems associated with the mandated manual inspection. Also, it is desirable that the condition of the lighting and signaling systems be known at all times to enable the correction of defects found in the lens and reflectors immediately, thus reducing the time to repair and improving maintenance.

### BRIEF DESCRIPTION

Briefly, in accordance with one embodiment of the present invention, a system for monitoring the condition of a lighting system includes a lamp assembly, where a lamp is disposed in a housing, and a lens disposed adjacent to the lamp, where a conductor is disposed on the lens and is adapted to lose electrical continuity upon occurrence of a crack in the lens. Furthermore, a monitoring system is coupled to the conductor and is configured to detect the loss of electrical continuity in the conductor, which is indicative of the occurrence of a crack in the railroad signal lens.

According to an aspect of the present invention, a method for monitoring status of a lighting system is presented. The method comprises disposing a lens in a lamp assembly, disposing a conductor over a desired region of the lens, where the conductor is adapted to lose electrical continuity upon occurrence of a crack in the lens, and monitoring the conductive path for a loss in electrical continuity.

Another aspect of the present invention is a method for monitoring the status of a lighting system. The method comprises monitoring a state of continuity of a conductor coupled to a lens in a lamp assembly, where the continuity is interrupted by a crack in the lens. Furthermore, the method comprises generating a signal in response to loss of continuity of the conductor indicative of occurrence of a crack in the lens.

In accordance with a further embodiment of the present invention, a lens configured for detecting cracks is presented. The lens is disposed adjacent to a lamp and a conductor is disposed in a region of the lens, where the conductor is adapted to lose a continuity in response to formation of a crack in the lens. Furthermore, the conductor comprises a plurality of leads configured to be coupled to a monitoring system and to provide a signal to a remote location representative of a state of continuity of the conductor.

In accordance with an embodiment of the present invention, a kit for monitoring status of a lighting system is presented. The kit comprises a lens and a conductor disposed in a region of the lens, where the conductor is adapted to lose electrical continuity upon occurrence of a crack in the lens.

According to a further aspect of the present invention, a system for monitoring the condition of a lighting system includes a lamp assembly where a lamp is disposed in a housing and a lens disposed adjacent to the lamp, where a conductor is disposed on the lens and is adapted to lose electrical continuity upon occurrence of a crack in the lens. In addition, a reflector is disposed adjacent to the lamp, where a reflector conductor is disposed on the reflector and is adapted to lose electrical continuity upon occurrence of a crack in the reflector. Furthermore, a monitoring system is coupled to the conductor and the reflector conductor and is configured to detect the loss of electrical continuity in the conductor and the reflector conductor, which is indicative of the occurrence of a crack in the railroad signal lens and the reflector respectively.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view illustrating an embodiment of a monitoring system for a lighting system implemented according to one aspect of the invention;

FIG. 2 is a diagrammatical view of an exemplary embodiment of a monitoring system, employed to monitor the railroad signal lens for cracks in a system as illustrated in FIG. 1;

FIG. 3 is an elevational view of an exemplary embodiment of a conductor in the form of a spiral grid pattern for use with a lens for monitoring its condition by means of a monitoring system as illustrated in FIG. 1 and FIG. 2, according to one aspect of the invention;

FIG. 4 is an elevational view of another exemplary embodiment of a conductor grid pattern for use with a lens to monitor its condition by means of a monitoring system as illustrated in FIG. 1 and FIG. 2, according to another aspect of the invention;

FIG. 5 is a cross-sectional view of an embodiment of a railroad signal lens in which a conductor is embedded inside the lens for monitoring its condition; and

FIG. 6 is a cross-sectional view of another embodiment of a railroad signal lens where a conductor is disposed on a rear surface of the railroad signal lens.

FIG. 7 is a cross-sectional view of another exemplary embodiment of a railroad signal lens and a reflector where a conductor is disposed on a rear surface of the reflector.

### DETAILED DESCRIPTION

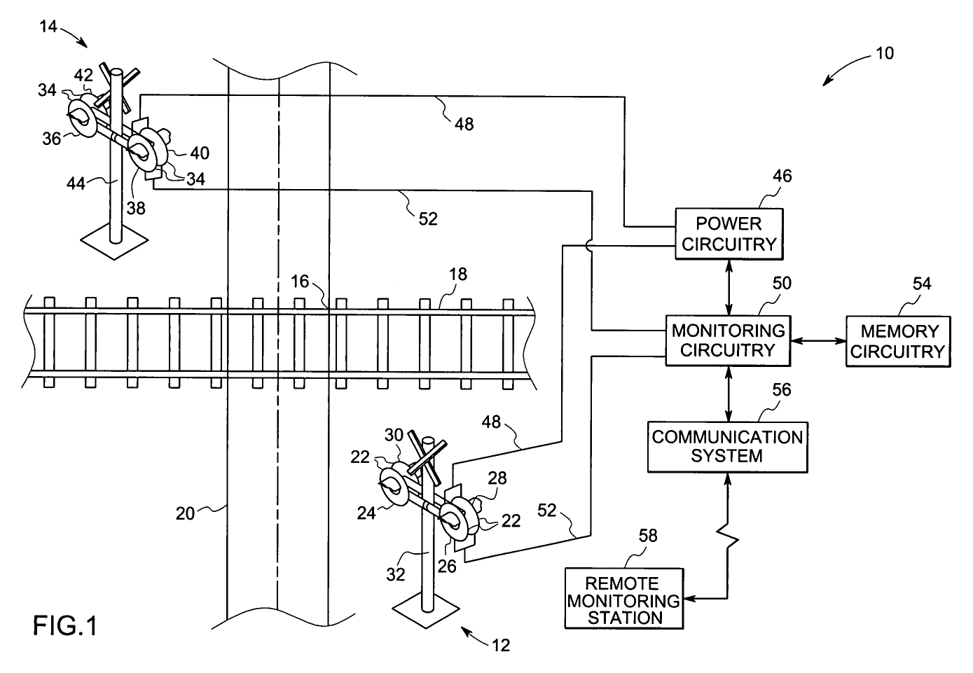

Turning now to the drawings, and referring to FIG. 1, a system 10 for monitoring the status of a lighting system is illustrated. In the illustrated embodiment, the lighting system condition monitoring system 10 is employed to monitor the condition of a railroad signal lens and reflector.

In a presently contemplated configuration, as shown in FIG. 1, the lighting system condition monitoring system 10, adapted to monitor the condition of a railroad signal lens, is illustrated diagrammatically as including railroad crossing warning signals. The signals are provided by flashing or steady light signals 12 and 14. The signals are, in the illustrated embodiment, installed at a crossing 16 of a railroad track 18 and a road 20.

Typically, the flashing light signal 12 consists of a cluster 22 of four lamp assemblies 24, 26, 28 and 30. In the cluster 22, two lamp assemblies 24 and 26 are positioned in a horizontal line. The other two lamp assemblies 28 and 30 are similarly positioned in a horizontal line, although offset from the first two assemblies. Furthermore, the first set of lamp assemblies 24 and 26 and the second set of lamp assemblies 28 and 30 are coupled to and supported on a mast 32 in a back-to-back configuration. In a similar fashion, the light signal 14 consists of a cluster 34 of four lamp assemblies 36, 38, 40 and 42. Two lamp assemblies 36 and 38 are situated in a horizontal line, as are the other two lamp assemblies 40 and 42. In addition, the first set of lamp assemblies 36 and 38 and the second set of lamp assemblies 40 and 42 are coupled to a mast 44 in a back-to-back configuration, in the same manner as the assemblies of cluster 22.

In general, each lamp assembly, for example the lamp assembly 24, includes a housing in which a lamp is disposed. A lens is disposed adjacent to the lamp and is sealed to the housing. Typically, the lens is constructed using glass or moldable polymeric material although other types of materials with similar properties may be used. In typical applications, the lenses may be colored or clear, shielded, partially shielded, or contoured or faceted to produce a desired emission pattern or effect.

In the illustrated embodiment of FIG. 1, coupling between each lamp assembly, such as lamp assembly 24, and power circuitry 46 may be accomplished by the use of leads 48. The lamp assembly 24 may also be connected to monitoring circuitry 50 via leads 52. The monitoring circuitry 50 is adapted to monitor the status of a railroad signal lens of a railroad signaling system. In addition, the monitoring circuitry 50 may also be coupled to memory circuitry 54, as well as to a communications system 56, which may in turn be connected to a remote monitoring station 58. The communication system 56 may be used to communicate the condition of the lighting system to the remote monitoring station 58.

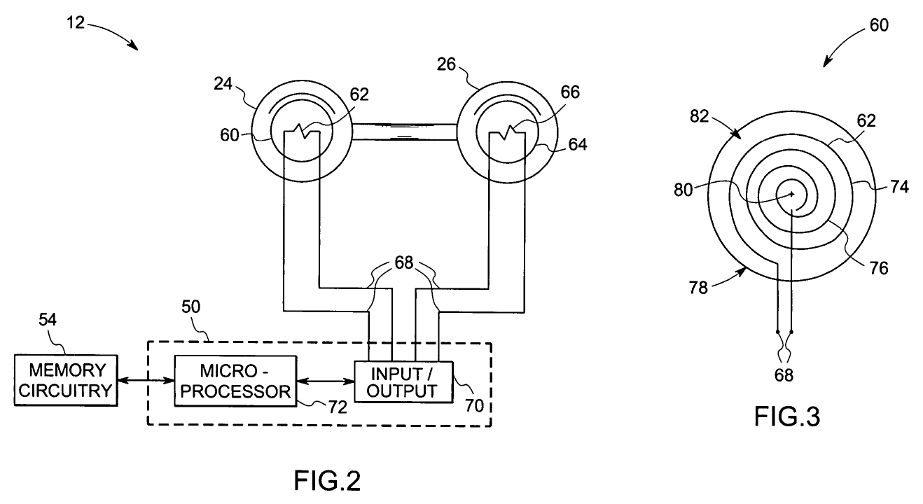

FIG. 2 illustrates a diagrammatical view of an exemplary embodiment of a monitoring system employed to monitor a railroad signal lens 60 for cracks in a system as illustrated in FIG. 1. In a present configuration, a railroad signal lens 60 is disposed adjacent to the lamp. Furthermore, the railroad signal lens 60 includes a conductor 62. In a similar manner a railroad signal lens 64 is disposed adjacent to the lamp 26. Additionally, the railroad signal lens 64 includes another conductor 66.

It may be desirable that the condition of the railroad signal lens 60 be known at all times. This facilitates the timely detection of the occurrence of cracks or defects in the railroad signal lens 60. Such cracks and defects may jeopardize the proper functioning and reliability of the signaling system, particularly if left uncorrected. To facilitate the monitoring of the condition of the railroad signal lens 60, the conductor 62 is disposed over a desired region of the railroad signal lens 60. The conductor 62, according to a present embodiment, includes a conductive wire or trace constructed using materials, such as, but not limited to metal alloys possessing mechanical properties such as low ductility and good corrosion resistance. Other conductive materials may, of course, be employed. Additionally, the conductor 62 is configured to provide a continuous conductive path and is adapted to lose electrical continuity (that is to break or otherwise undergo a detectible change in conductive properties) upon occurrence of cracks in the railroad signal lens 60. Leads 68 enable the coupling of the conductor 62 to the monitoring circuitry 50.

The monitoring circuitry 50, which facilitates the monitoring of the condition of the railroad signal lens 60, is configured to detect loss of electrical continuity, in the conductor 62, which may be indicative of cracks or defects in the railroad signal lens 60. The monitoring circuitry 50 may include an input/output module 70, which facilitates the connection between the conductor 62 and the monitoring circuitry 50. The monitoring circuitry 50 may also include a control or monitoring circuit, such as a microprocessor unit 72 that may be coupled to the input/output module 70. The microprocessor unit 72 may aid in interpreting the condition of the railroad signal lens 60. The microprocessor unit 72 may also assist in identifying the particular railroad signal lens of a lamp assembly within the cluster 22, the condition of which has been altered. This capability allows for identification and localization of the lamp or lens where service is required. The monitoring circuitry 50 may be coupled to memory circuitry 54 which may facilitate storing information regarding the condition of the railroad signal lens 60. Subsequently, the information regarding the condition of the railroad signal lens 60 may be utilized to generate timely reports or be transmitted to the remote monitoring station 58.

Referring now to FIG. 3, an elevational view of an exemplary embodiment of the conductor 62 of FIG. 2 is illustrated. The conductor 62 is configured in the form of a grid pattern 74. Subsequently, the grid pattern 74 is disposed over the railroad signal lens 60 and is configured to encompass a desired, typically a maximum area of the railroad signal lens 60. Additionally, the conductor grid pattern 74, which is configured to provide a continuous conductive path, is adapted to lose continuity on occurrence of anomalies in the railroad signal lens 60.

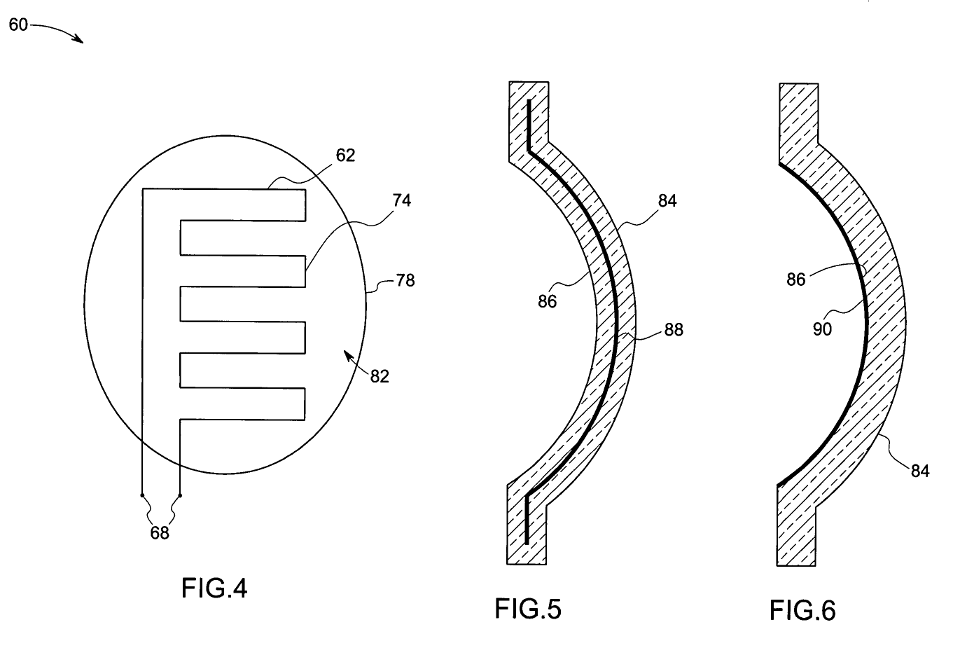

The conductor 62 may be configured in various grid patterns as illustrated in FIG. 3 and FIG. 4. According to one aspect of the invention, the conductor 62 is patterned in the form of a spiral grid pattern 76 and disposed over the body 78 of the railroad signal lens 60 as shown in FIG. 3. Alternatively, FIG. 4 shows another exemplary grid pattern 74 of the conductor 62 and disposed over the body 78 of the railroad signal lens 60. Other patterns may, of course, be envisaged, particularly depending upon the size, shape and configuration of the lens. In certain lenses, for example, cracks may be more likely in certain locations, such as near edges or facets, and the conductor pattern may be adapted accordingly.

To facilitate the monitoring of the condition of the railroad signal lens 60, the spiral grid pattern 76, as shown in FIG. 3, is configured to encompass a central region 80 and a peripheral region 82 of the railroad signal lens 60. The conductor 62, in the form of the spiral grid pattern 76, is configured to lose electrical continuity on the occurrence of a crack in the railroad signal lens 60. The monitoring circuitry 50 is coupled to the conductor 62 in the form of the spiral grid pattern 76, via a plurality of leads 68. The operational state of the conductor 62 is continuously monitored by the monitoring circuitry 50, which is configured to apply a monitoring signal to the conductor 62 during operation. In addition, the monitoring circuitry 50 is adapted to generate a signal in response to loss of electrical continuity, which is indicative of formation of a crack in the railroad signal lens 60. Furthermore, the output signal, indicating the formation of a crack in the railroad signal lens 60, may be relayed to the remote monitoring station 58.

FIG. 5 and FIG. 6 diagrammatically illustrate cross-sectional views of the railroad signal lens 60 in which the placement of the conductor grid pattern 74 on the railroad signal lens 60, to facilitate the monitoring of the condition of the railroad signal lens 60, are represented. Typically, the railroad signal lens 60 has a front surface 84 and a rear surface 86. In one embodiment the conductor grid pattern 74 is embedded in the railroad signal lens 60 as represented in FIG. 5. The embodiment of FIG. 5 illustrating the embedded conductor grid pattern 88 may be employed when the replacement of the railroad signal lens 60 is required. Alternatively, the conductor grid pattern 74 is fitted on a decal 90 that may be disposed on the rear surface 86 of the railroad signal lens 60 as illustrated in FIG. 6.

In accordance with another embodiment of the present invention, a kit for monitoring the status of the lighting system 10 is presented. Such a kit may include a railroad signal lens 60 and the conductor 62 disposed in a region of the railroad signal lens 60. The conductor 62 of the kit may include a conductor grid pattern 74 in the form of the decal 90 that is applied on the rear surface 86 of the railroad signal lens 60 as illustrated in FIG. 6. The conductor 62 is configured to lose electrical continuity upon occurrence of a crack in the railroad signal lens 60. If on inspection an existing railroad signal lens 60 is found to be in working condition and does not require replacement, the kit in the form of the decal 90, illustrated in FIG. 6, may be used to retrofit the railroad signal lens 60.

The lighting system condition monitoring system 10 and method described hereinabove enable the continuous monitoring of the status of the railroad signal lens 60 by means of the conductor 62 configured in various grid patterns 74 and disposed on the railroad signal lens 60. The present technique thus permits detection of very fine cracks and defects that might not be immediately visible on cursory inspection. In addition, since the condition of the railroad signal lens 60 is monitored continuously, the damage to the railroad signal lens 60 can be sensed and reported immediately thus reducing time to repair and improving maintenance. Moreover, since the change in the condition of the railroad signal lens 60 can be sensed remotely, a maintenance person may be sent to the railroad crossing 16 only when an anomaly in the railroad signal lens 60 is sensed, thus greatly reducing the cost of inspection.

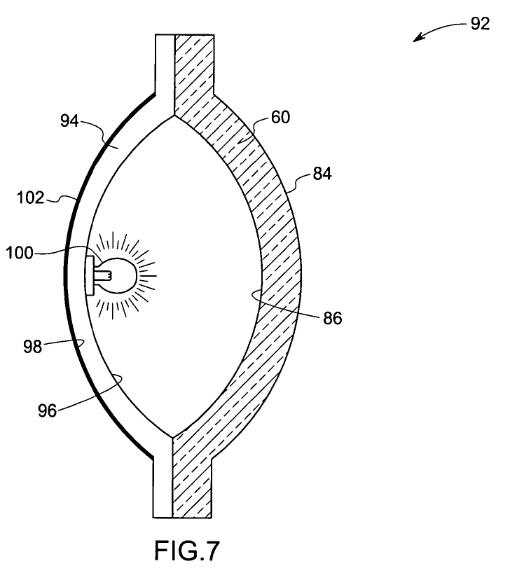

In a further embodiment 92 illustrated in FIG. 7, the lighting system condition monitoring system further comprises a reflector 94. In general, each lamp assembly, for example the lamp assembly 24 (see FIG. 1), includes a housing in which a lamp is disposed. A lens 60 (see FIG. 2) is disposed adjacent to the lamp and is sealed to the housing. In a similar fashion, the reflector 94, comprising a front surface 96 and a rear surface 98, is disposed adjacent to the lamp 100. Typically, the reflector 94 is constructed using glass or moldable polymeric material although other types of materials with similar properties may be used.

It may be desirable that the condition of the reflector 94 be known at all times. This facilitates the timely detection of occurrence of cracks or defects in the reflector 94. In order to enable the timely detection of cracks or defects in the reflector 94, a reflector conductor 102 is disposed over a desired region of the reflector 94. For example, the reflector conductor 102 may be configured to be disposed on a non-reflective surface of the reflector 94, that is the rear surface 98 of the reflector 94. The reflector conductor 102, according to a present embodiment, includes a conductive wire or trace constructed using materials, such as, but not limited to metal alloys possessing mechanical properties such as low ductility and good corrosion resistance. Other conductive materials may also be employed. Furthermore, the reflector conductor 102 may be configured in various grid patterns as illustrated in FIG. 3 and FIG. 4. In addition, the reflector conductor 102 is configured to provide a continuous conductive path and is adapted to break or otherwise undergo a detectible change in conductive properties (that is lose electrical continuity) upon occurrence of cracks in the reflector 94. The reflector conductor 102 may be coupled to the monitoring system 50 (see FIG. 1) which is configured to detect loss of electrical continuity, in the reflector conductor 102, which may be indicative of cracks or defects in the reflector 94.

The lighting system condition monitoring system 10 and method described hereinabove enable the continuous monitoring of the status of the railroad signal lens 60 by means of the conductor 62 configured in various grid patterns 74 and disposed on the railroad signal lens 60. Similarly, the lighting system condition monitoring system 10 and method described hereinabove enable the continuous monitoring of the status of the reflector 94 by means of the reflector conductor 102 configured in various grid patterns 74 and disposed on the reflector 94. The present technique thus permits detection of very fine cracks and defects in the reflector 94 that might not be immediately visible on cursory inspection. In addition, since the condition of the railroad signal lens 60 and reflector 94 is monitored continuously, the damage to the railroad signal lens 60 and reflector 94 may be sensed and reported immediately thus reducing time to repair and improving maintenance. Moreover, because the change in the condition of the railroad signal lens 60 and reflector 94 can be sensed remotely, a maintenance person may be sent to the railroad crossing 16 only when an anomaly in the railroad signal lens 60 and/or the reflector 94 is sensed, thus greatly reducing the cost of inspection.

The various aspects of the system described hereinabove have utility in several other lighting and signaling systems that make use of lamps and lighting equipment and are subject to periodic inspections. One such application is the airport signaling systems, where periodic inspections of runway lights may be desirable. As noted above, the proposed method may also find application in buoy lights and traffic lights where the reliability of the lighting system is of paramount importance.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for monitoring status of a lighting system, the system comprising:
a lamp assembly comprising a housing and a lamp disposed in the housing;
a lens disposed adjacent to the lamp, the lens comprising a conductor adapted to lose electrical continuity upon occurrence of a crack in the lens; and
a monitoring system coupled to the conductor and configured to detect the loss of electrical continuity in the conductor.

2. The system of claim 1, wherein the lens comprises glass.

3. The system of claim 1, wherein the lens comprises a moldable polymeric material.

4. The system of claim 1, wherein the lens is sealed to the housing.

5. The system of claim 1, wherein the conductor comprises a conductive wire.

6. The system of claim 1, wherein the conductor comprises a decal configured to be disposed on a surface of the lens.

7. The system of claim 1, wherein the conductor is embedded in the lens.

8. The system of claim 1, wherein the conductor defines a continuous path disposed over a desired region of the lens.

9. The system of claim 8, wherein the region comprises a central region of the lens.

10. The system of claim 8, wherein the region comprises a peripheral region of the lens.

11. The system of claim 1, further comprising a communication system for transmitting a signal to a remote location, representative of a state of continuity of the conductor.

12. A kit for monitoring status of a lighting system, the kit comprising:
a lens; and
a conductor disposed in a region of the lens, wherein the conductor is adapted to lose electrical continuity upon occurrence of a crack in the lens.

13. The kit of claim 12, wherein the lens comprises glass.

14. The kit of claim 12, wherein the lens comprises a moldable polymeric material.

15. The kit of claim 12, wherein the conductor comprises a conductive wire.

16. The kit of claim 12, wherein the conductor comprises a decal configured to be applied to a rear surface of the lens.

17. The kit of claim 12, wherein the region comprises a central region of the lens.

18. The kit of claim 12, wherein the region comprises a peripheral region of the lens.

19. A method for monitoring status of a lighting system, the method comprising:
disposing a lens in a lamp assembly;
disposing a conductor over a desired region of the lens, the conductor adapted to lose electrical continuity upon occurrence of a crack in the lens; and
monitoring the conductive path for a loss in electrical continuity.

20. The method of claim 19, wherein disposing the lamp in the lamp assembly comprises sealing the lens in a lamp housing.

21. The method of claim 19, wherein monitoring the conductive path comprises coupling the conductor to an electrical monitoring system configured to apply a monitoring signal to the conductor during operation.

22. A method for monitoring status of a lighting system, the method comprising:
monitoring a state of continuity of a conductor coupled to a lens in a lamp assembly, wherein the continuity is interrupted by a crack in the lens; and
generating a signal in response to loss of continuity of the conductor indicative of occurrence of a crack in the lens.

23. The method of claim 22, further comprising providing an output signal to a location remote from the lighting system, the output signal providing an indication of the operational state of the lens.

24. A lens configured for detecting cracks comprising:
a lens disposed adjacent to a lamp; and
a conductor disposed in a region of the lens, wherein the conductor is adapted to lose a continuity in response to formation of a crack in the lens, the conductor comprising a plurality of leads configured to be coupled to a monitoring system and to provide a signal to a remote location representative of a state of continuity of the conductor.

25. The crack detection lens of claim 24, wherein the conductor comprises a conductive wire.

26. The crack detection lens of claim 24, wherein the region comprises a central region of the lens.

27. The crack detection lens of claim 24, wherein the region comprises a peripheral region of the lens.

28. A system for monitoring status of a lighting system, the system comprising:
a lamp assembly comprising a housing and a lamp disposed in the housing;
a lens disposed adjacent to the lamp;
a reflector disposed adjacent to the lamp, the reflector comprising a reflector conductor adapted to lose electrical continuity upon occurrence of a crack in the reflector; and
a monitoring system coupled to the reflector conductor and configured to detect the loss of electrical continuity in the reflector conductor.

29. The system of claim 28, further comprising a conductor disposed on the lens and adapted to lose electrical continuity upon occurrence of a crack in the lens, and a monitoring system coupled to the conductor and configured to detect the loss of electrical continuity in the conductor.

30. The system of claim 28, wherein the reflector comprises glass.

31. The system of claim 28, wherein the reflector comprises a moldable polymeric material.

32. The system of claim 28, wherein the reflector conductor comprises a conductive wire.

33. The system of claim 28, wherein the reflector conductor is configured to be disposed on a rear surface of the reflector.

34. The system of claim 28, wherein the reflector conductor is configured to be defines a continuous path disposed over a desired region of the reflector.

35. The system of claim 28, further comprising a communication system for transmitting a signal to a remote location, representative of a state of continuity of the reflector conductor.
